(19) United States
(12) Patent Application Publication
(10) Pub. No.: US 2004/0060064 A1
(43) Pub. Date: Mar. 25, 2004

(54) Methods and systems for purchasing lottery tickets via a television terminal

(75) Inventor: Christopher Poli, Doylestown, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/256,050

(22) Filed: Sep. 25, 2002

(51) Int. Cl. H04N 7/16; G06F 3/00; H04N 5/445; G06F 13/00

(52) U.S. Cl. 725/61; 725/23; 725/26; 725/27

(57) ABSTRACT

The present invention relates to the purchase of lottery tickets via a television terminal. A lottery interface is provided to enable communications between the television terminal and a lottery system. A lottery application residing on the television terminal enables communication of a lottery ticket purchase request to the lottery interface via an upstream television path. A user interface is provided which is capable of accessing the lottery application residing on the television terminal. A lottery ticket purchase request is initiated via the user interface. The user interface accesses the lottery application in order to generate the purchase request. The purchase request is then communicated over an upstream television path from the lottery application to the lottery interface. The purchase request is forwarded from the lottery interface to the lottery system, where a purchase of the lottery ticket is completed.

### BACKGROUND OF THE INVENTION

The present invention relates to the field of satellite and cable television systems. More specifically, the present invention relates to enabling the purchase of lottery tickets from a state lottery system via a television terminal utilizing an existing television network.

As television systems continue to develop, particularly digital television systems, more and more features are being added to the television terminal, such as pay-per-view, electronic program guides, digital video recording capabilities, electronic shopping capabilities, video-on-demand, weather and stock information, as well as Internet access and related interactive features.

Currently, lottery tickets are sold through agents on behalf of state lottery commissions. High lottery jackpots frequently lead to long lines for ticket purchases at agent locations, such as convenience stores, gas stations, liquor stores, and the like.

It would be advantageous to extend the capabilities of a television system to enable the purchase of lottery tickets through a television terminal. It would be further advantageous to provide for the purchase of said lottery tickets from a lottery system over the existing television system network.

The methods and systems of the present invention provide the foregoing and other advantages.

### SUMMARY OF THE INVENTION

The present invention relates to methods and systems for the purchase of lottery tickets via a television terminal. A lottery interface is provided to enable communications between the television terminal and a lottery system. A lottery application residing on the television terminal enables communication of a lottery ticket purchase request to the lottery interface via an upstream television path. A user interface is provided which is capable of accessing the lottery application residing on the television terminal and initiating the lottery ticket purchase request.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention; and

FIG. 2 shows a block diagram of a further example embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

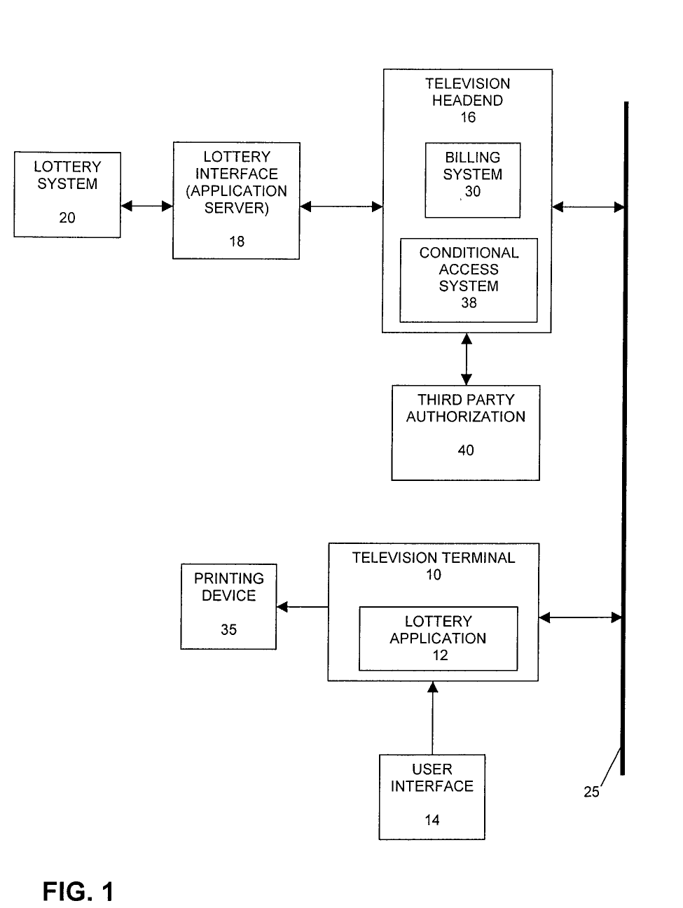

The present invention relates to methods and systems for the purchase of lottery tickets via a television terminal. In an example embodiment as shown in FIG. 1, a lottery interface 18 is provided to enable communications between a television terminal 10 and a lottery system 20. A lottery application 12 residing on the television terminal 10 enables communication of a lottery ticket purchase request to the lottery interface 18 via an upstream television path of a television network 25. A user interface 14 is provided which is capable of accessing the lottery application 12 residing on the television terminal 10.

A lottery ticket purchase request is initiated via the user interface 14. The user interface 14 accesses the lottery application 12 residing on the television terminal 10 in order to generate the purchase request. The purchase request is then communicated over an upstream television path (of television network 25) from the lottery application 12 to the lottery interface 18. The communication between the television terminal 10 and the lottery interface 18 may take place via a television system headed 16 as shown FIG. 1. The purchase request is forwarded from the lottery interface 18 to the lottery system 20, where a purchase of the lottery ticket is completed as requested in the purchase request.

A confirmation of the purchase may be provided from the lottery system 20 to the television terminal 10. The confirmation of the purchase may comprises at least one of a name of a user, an address of the user, an order number, a listing of selected lottery numbers, a dollar amount of the purchase, or prize claim information. The confirmation of the purchase may be printed on a printing device 35 associated with the television terminal 10.

The lottery interface 18 may comprise a lottery application server. Those skilled in the art will appreciate that this server 18 may be located at a television system headend, at the lottery system facility, or at a remote location independent of the headend and the lottery system. Further, those skilled in the art will appreciate that the lottery application server 18 may be under the control of the television system headend 16, the lottery system 20, or a third party provider.

The user interface 14 may comprise one of a remote control, a keyboard, a mouse, a joystick, a touch pad, or similar device which can be enabled for communication with the television terminal 10 and capable of accessing the lottery application 12.

In a further example embodiment, authorization of the purchase of the lottery ticket in response to the purchase request may be required. Such authorization may be performed at a remote location (e.g., third party authorization 40) via communications through a television system headend 16. Alternatively, authorization for the purchase may be performed at the television system headend 16. The authorization may comprise verifying the identity of a user making the purchase request and verifying the credit of the user. The authorization may be enabled via one of a smart card (e.g., via a smart card interface associated with television terminal 10 or user interface 14) or a television system conditional access system 38.

Payment for purchase of the lottery ticket may be enabled via one of a smart card or a conditional access system 38. Prepayment for the purchase of the lottery ticket may be required. Payment may be made via one of a smart card, a credit card, a debit card, or a television billing system 30. A portion of the payment may be provided to a television system operator, with the remainder of the payment being provided to the lottery system 20.

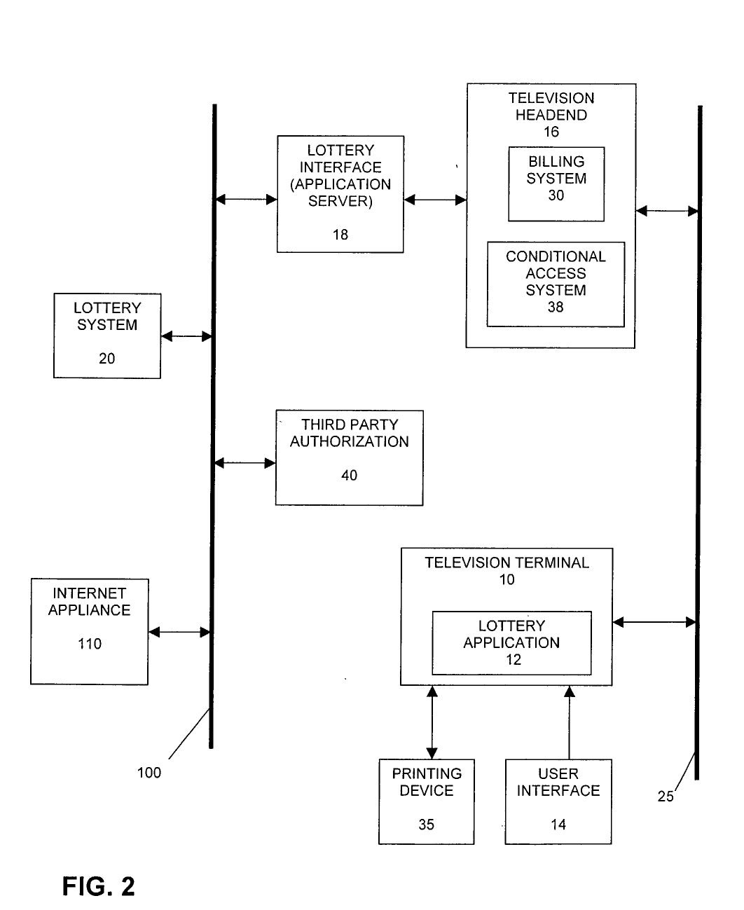

A further example embodiment is shown in FIG. 2, wherein the lottery application server 18 communicates with the lottery system 20 via a global communications network 100 (e.g., the Internet). Third party authorization 40 may also take place over the global communication network 100. In such an embodiment, confirmation of the purchase may be forwarded by electronic mail (email) from the lottery system to the user. The email may be received by the user via the television terminal 10 in the case of an Internet enabled television embodiment. Alternatively, the email may be received by the user on an Internet appliance 110, such as a personal computer, personal digital assistant, digital cellular telephone, or other Internet enabled appliance as is known in the art.

It should now be appreciated that the present invention provides advantageous methods and systems for purchasing lottery tickets via a television terminal.

Although the invention has been described in connection with various illustrated embodiments, numerous modifications and adaptations may be made thereto without departing from the spirit and scope of the invention as set forth in the claims.

What is claimed is:

1. A method for purchasing lottery tickets via a television terminal, comprising:
initiating a lottery ticket purchase request via a user interface capable of accessing a lottery application residing on the television terminal;
communicating said purchase request over an upstream television path from the lottery application to a lottery interface;
forwarding the purchase request from the lottery interface to a lottery system; and
completing a purchase of said lottery ticket as requested in said purchase request.

2. A method in accordance with claim 1, further comprising:
providing a confirmation of said purchase from said lottery system to said television terminal.

3. A method in accordance with claim 2, wherein said confirmation of said purchase comprises at least one of a name of a user, an address of said user, an order number, a listing of selected lottery numbers, a dollar amount of said purchase, or prize claim information.

4. A method in accordance with claim 2, further comprising:
printing said confirmation of said purchase on a printing device associated with said television terminal.

5. A method in accordance with claim 1, further comprising:
emailing a confirmation of said purchase from said lottery system to a user.

6. A method in accordance with claim 1, wherein:
said lottery interface comprises a lottery application server.

7. A method in accordance with claim 1, wherein:
said user interface comprises one of a remote control, a keyboard, a mouse, a joystick, or a touch pad.

8. A method in accordance with claim 1, further comprising:
authorizing the purchase of said lottery ticket in response to said purchase request.

9. A method in accordance with claim 8, wherein:
said authorization is performed at a remote location via communications through a television system headend.

10. A method in accordance with claim 8, wherein:
said authorization is performed at a television system headend.

11. A method in accordance with claim 8, wherein said authorization comprises:
verifying the identity of a user making said purchase request; and
verifying the credit of said user.

12. A method in accordance with claim 8, wherein said authorization is enabled via one of a smart card or a television system conditional access system.

13. A method in accordance with claim 12, wherein payment for purchase of said lottery ticket is enabled via one of said smart card or said conditional access system.

14. A method in accordance with claim 1, further comprising:
obtaining payment for said lottery ticket.

15. A method in accordance with claim 14, wherein said payment comprises a prepayment.

16. A method in accordance with claim 14, wherein said payment is enabled via one of a smart card, a credit card, a debit card, or a television billing system.

17. A method in accordance with claim 14, further comprising:
providing a portion of said payment to a television system operator; and
providing the remainder of said payment to said lottery system.

18. A system for purchasing lottery tickets via a television terminal, comprising:
a lottery interface to enable communications between said television terminal and a lottery system;
a lottery application residing on the television terminal to enable communication of a lottery ticket purchase request to said lottery interface via an upstream television path; and
a user interface capable of accessing said lottery application residing on the television terminal and initiating said lottery ticket purchase request.

19. A system in accordance with claim 18, wherein:
the purchase request is forwarded from the lottery interface to a lottery system; and
a purchase of said lottery ticket is completed as requested in said purchase request.

20. A system in accordance with claim 19, wherein:
a confirmation of said purchase is provided from said lottery system to said television terminal.

21. A system in accordance with claim 20, wherein said confirmation of said purchase comprises at least one of a name of a user, an address of said user, an order number, a listing of selected lottery numbers, a dollar amount of said purchase, or prize claim information.

22. A system in accordance with claim 20, wherein:
said confirmation of said purchase is printed on a printing device associated with said television terminal.

23. A system in accordance with claim 19, wherein:
a confirmation of said purchase is emailed from said lottery system to a user.

24. A system in accordance with claim 18, wherein:
said lottery interface comprises a lottery application server.

25. A system in accordance with claim 18, wherein:
said user interface comprises one of a remote control, a keyboard, a mouse, a joystick, or a touch pad.

26. A system in accordance with claim 18, wherein:
purchase of said lottery ticket is authorized in response to said purchase request.

27. A system in accordance with claim 26, wherein:
said authorization is performed at a remote location via communications through a television system headend.

28. A system in accordance with claim 26, wherein:
said authorization is performed at a television system headend.

29. A system in accordance with claim 26, wherein said authorization comprises:
verifying the identity of a user making said purchase request; and
verifying the credit of said user.

30. A system in accordance with claim 26, wherein said authorization is enabled via one of a smart card or a television system conditional access system.

31. A system in accordance with claim 30, wherein payment for purchase of said lottery ticket is enabled via one of said smart card or said conditional access system.

32. A system in accordance with claim 18, wherein:
payment for said lottery ticket is obtained.

33. A system in accordance with claim 32, wherein said payment comprises a prepayment.

34. A system in accordance with claim 32, wherein said payment is enabled via one of a smart card, a credit card, a debit card, or a television billing system.

35. A system in accordance with claim 32, wherein:
a portion of said payment is provided to a television system operator; and
providing the remainder of said payment is provided to said lottery system.
